(19) United States
(12) Patent Application Publication
(10) Pub. No.: US 2021/0288761 A1
(43) Pub. Date: Sep. 16, 2021

(54) METHOD OF CODEWORD MAPPING AND TRANSMISSION AND RECEPTION POINT

(71) Applicants: NTT DOCOMO, INC., Tokyo (JP); DOCOMO INNOVATIONS, INC, Palo Alto, CA (US)

(72) Inventors: Yuichi Kakishima, Tokyo (JP); Kazuki Takeda, Tokyo (JP); Yosuke Sano, Tokyo (JP); Lihui Wang, Tokyo (JP); Satoshi Nagata, Tokyo (JP)

(73) Assignee: NTT DOCOMO, INC., Tokyo (JP)

(21) Appl. No.: 16/610,837

(22) PCT Filed: May 3, 2018
(86) PCT No.: PCT/US2018/030824

§ 371 Date: Nov. 4, 2019

Related U.S. Application Data
(60) Provisional application No. 62/501,319, filed on May 4, 2017.

(51) Int. Cl. H04L 1/18; H04W 72/04

(52) U.S. Cl. CPC H04L 1/1893; H04W 72/04

(57) ABSTRACT

A method of codeword (CW) mapping in a wireless communication system includes determining, with a Transmission and Reception Point (TRP), order of resources mapped to the CW, and mapping, with the TRP, the CW to resources in accordance with the determined order. The order of resources is determined based on a frequency resource, a time resource, and a layer. The determining determines the order based on a type of re¬ transmission control. The type of re-transmission control is CW-level Hybrid Automatic Repeat Request (HARQ) and code block group (CBG)-level HARQ. When the CW-level HARQ is applied, the determining determines the order as order of the layer, the frequency resource, and the time resource. When the CBG-level HARQ is applied, the determining determines the order as order of the frequency resource, the layer, and the time resource.

### TECHNICAL FIELD

One or more embodiment relate to a method of codeword (CW) mapping and a Transmission and Reception Point (TRP).

### BACKGROUND

In Long Tenn Evolution (LTE)/LTE-Advanced (LTE-A), downlink and uplink data is divided into more than one codewords (CWs) that is further composed of more than one codeblocks (CBs). The CW is a unit of re-transmission of Hybrid Automatic Repeat reQuest (HARQ). An LTE/LTE-A packet (CW mapping) has been designed to achieve Multiple-Input and Multiple-Output (MIMO) spatial diversity gain. More specifically, a modulated signal sequence is mapped in order of MIMO layer, subcarrier (frequency), and Orthogonal Frequency-Division Multiplexing (OFDM) symbol (time) for the downlink transmission.

On the other hand, in New Radio (NR), CB group (CBG)-level HARQ is additionally introduced in order to support a scenario with both of enhanced mobile broadband (eMBB) and ultra-reliable low latency communication (URLLC). In such a case, a packet may be beneficial to be mapped to have diverged Rx performance, because the HARQ can be performed with higher granularity. However, in the 3rd Generation Partnership Project (3GPP) standards, CW mapping methods for NR depending on HARQ schemes have not been determined.

### CITATION LIST

### Non-Patent Reference

Non-Patent Reference 1: 3GPP, TS 36.211 V 14.2.0

Non-Patent Reference 2: 3GPP, TS 36.213 V14.2.0

### SUMMARY

One or more embodiments of the present invention relate to a method of codeword (CW) mapping in a wireless communication system that includes determining, with a Transmission and Reception Point (TRP), order of resources mapped to the CW, and mapping, with the TRP, the CW to resources in accordance with the determined order.

One or more embodiments of the present invention relate to a TRP that includes a processor that determines order of resources mapped to CW, and a transmitter that notifies a UE of the determined order. The processor that maps the CW to resources in accordance with the determined order.

One or more embodiments of the present invention can provide a method of CW mapping depending on HARQ schemes.

Other embodiments and advantages of the present invention will be recognized from the description and figures.

### BRIEF DESCRIPTION OF THE DRAWINGS

FIG. 1 is a diagram showing a configuration of a wireless communication system according to one or more embodiments of the present invention.

FIGS. 2A-2F are diagrams showing first to sixth codeword mapping methods according to one or more embodiments of the present invention.

FIG. 3 is a flowchart diagram showing an operation example of codeword mapping according to one or more embodiments of a first example of the present invention.

FIG. 4 is a flowchart diagram showing an operation example of codeword mapping according to one or more embodiments of a second example of the present invention.

FIG. 5 is a flowchart diagram showing an operation example of codeword mapping according to one or more embodiments of a second example of the present invention.

FIGS. 6A-6C are diagrams showing codeword mapping methods according to one or more embodiments of a fifth example of the present invention.

FIGS. 7A-7C are diagrams showing codeword mapping methods according to one or more embodiments of the fifth example of the present invention.

FIGS. 8A-8C are diagrams showing codeword mapping methods according to one or more embodiments of the fifth example of the present invention.

FIGS. 9A and 9B are diagrams showing codeword mapping methods according to one or more embodiments of a fifth modified example of the present invention.

FIGS. 10A and 10B are diagrams showing codeword mapping methods according to one or more embodiments of the fifth example of the present invention.

FIG. 11 is a diagram showing a schematic configuration of the TRP according to one or more embodiments of the present invention.

FIG. 12 is a diagram showing a schematic configuration of the UE according to one or more embodiments of the present invention.

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

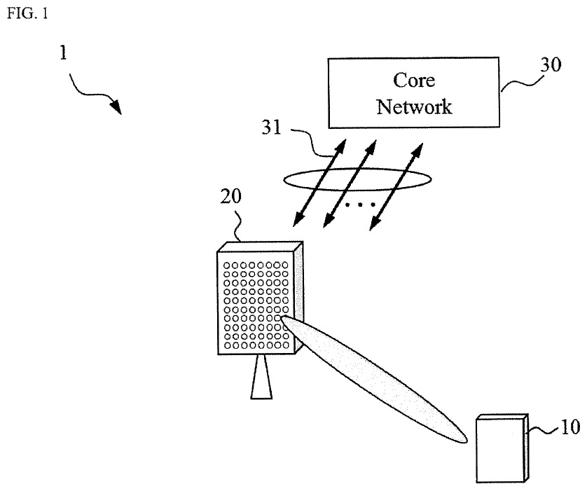

FIG. 1 is a wireless communications system 1 according to one or more embodiments of the present invention. The wireless communication system 1 includes a user equipment (UE) 10, a transmission and reception point (TRP) 20, and a core network 30. The wireless communication system 1 may be a New Radio (NR) system. The wireless communication system 1 is not limited to the specific configurations described herein and may be any type of wireless communication system such as an LTE/LTE-Advanced (LTE-A) system.

The TRP 20 may communicate uplink (UL) and downlink (DL) signals with the UE 10 in a cell of the TRP 20. The DL and UL signals may include control information and user data. The TRP 20 may communicate DL and UL signals with the core network 30 through backhaul links 31. The TRP 20 may be referred to as a base station (BS). The TRP 20 may be gNodeB (gNB).

The TRP 20 includes antennas, a communication interface to communicate with an adjacent TRP 20 (for example, X2 interface), a communication interface to communicate with the core network 30 (for example, S1 interface), and a CPU (Central Processing Unit) such as a processor or a circuit to process transmitted and received signals with the UE 10. Operations of the TRP 20 may be implemented by the processor processing or executing data and programs stored in a memory. However, the TRP 20 is not limited to the hardware configuration set forth above and may be realized by other appropriate hardware configurations as understood by those of ordinary skill in the art. Numerous TRPs 20 may be disposed so as to cover a broader service area of the wireless communication system 1.

The UE 10 may communicate DL and UL signals that include control information and user data with the TRP 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the TRP 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

In one or more embodiments of the present invention, the TRP 20 may generate codewords (CWs) by dividing transmission data. The CW is a data stream after channel coding process. The CW may be used as a unit of re-transmission or link adaptation. The generated CWs may be mapped to multiple layers, frequency resources, and time resources. For example, the frequency resources may be subcarriers. For example, the time resources may be Orthogonal Frequency-Division Multiplexing (OFDM) symbols. The CW is composed of multiple codeblocks (CBs). Transmission quality (diversity gains) may be different depending on mapping order of the multiple layers, the frequency resources, and the time resources.

In one or more embodiments of the present invention, mapping the CW to the resources indicates mapping bits within the CW to the resources.

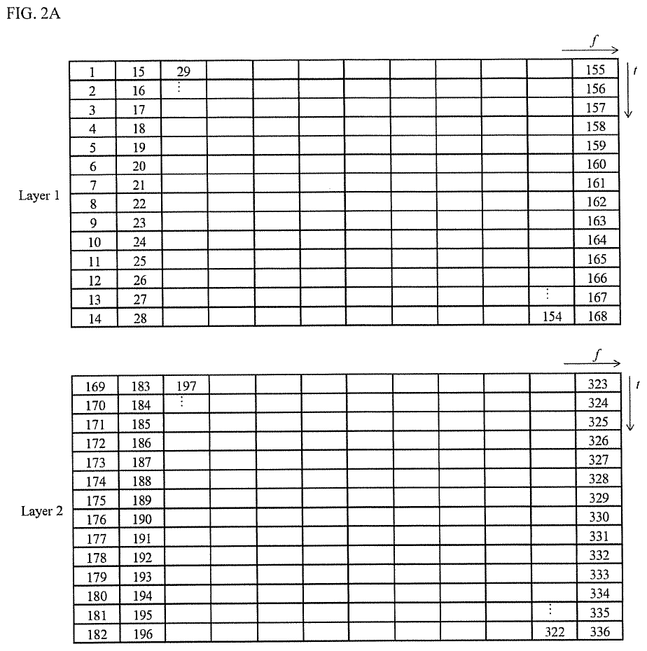

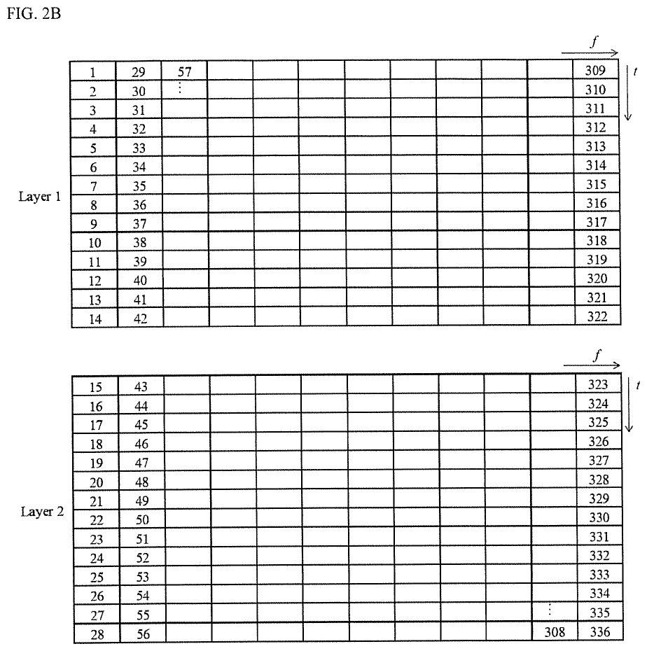

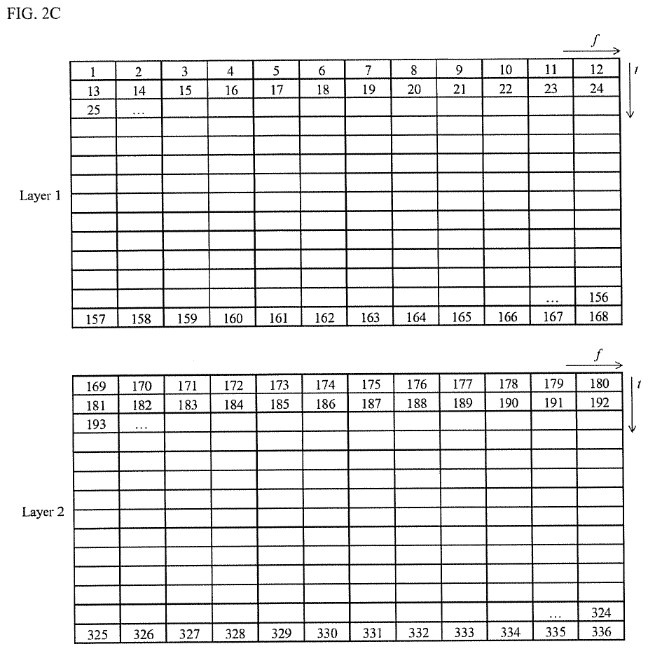

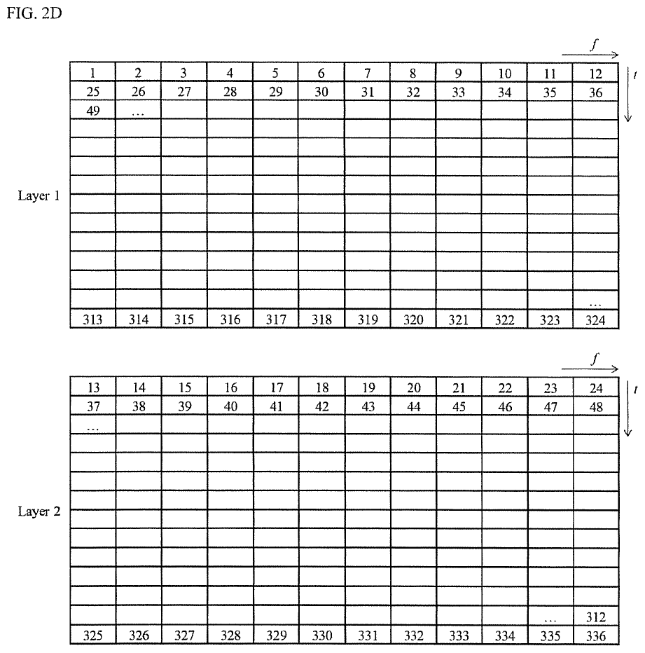

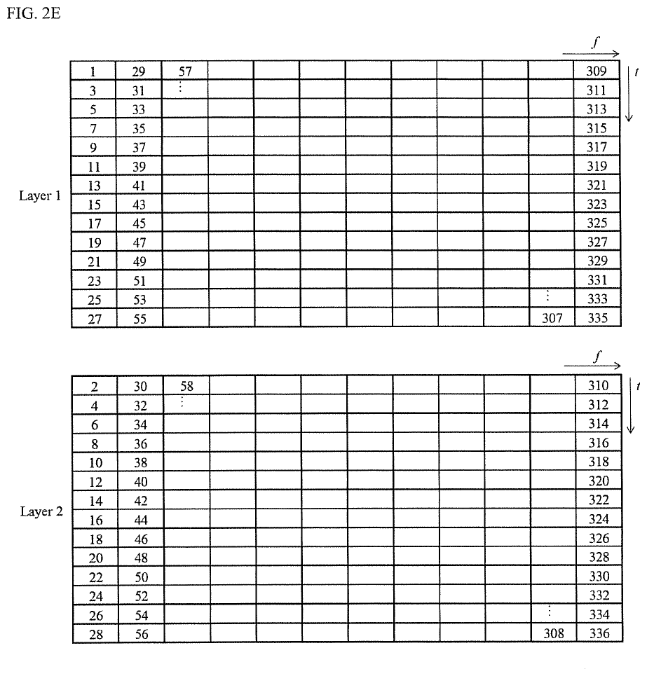

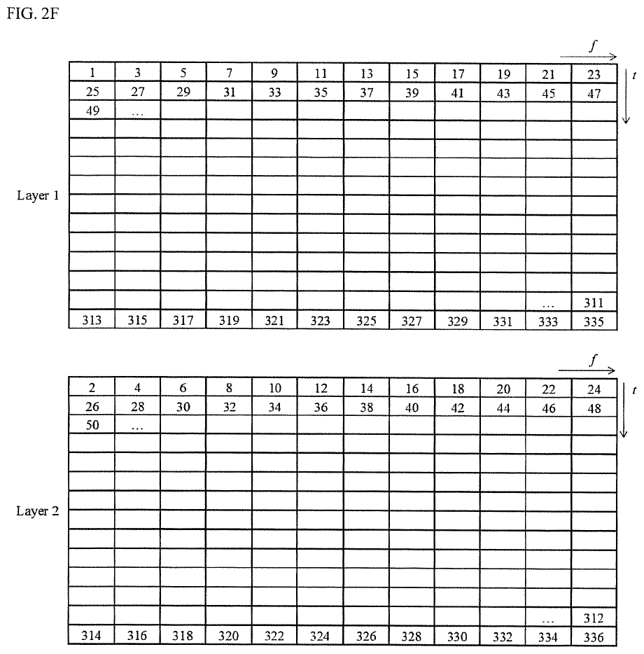

According to one or more embodiments of the present invention, the following CW mapping methods may be used. First to sixth CW mapping methods will be described below, with reference to FIGS. 2A-2F. FIGS. 2A-2F are diagrams showing the first to sixth CW mapping methods, respectively. A horizontal axis in FIGS. 2A-2F is a frequency axis and each component in the frequency axis indicates a frequency resource (e.g., subcarrier). A vertical axis in FIGS. 2A-2F is a time axis and each component in the time axis indicates a time resource (e.g., OFDM symbol). A resource identified by the frequency resource and the time resource may be a resource element (RE), for example. FIGS. 2A-2F show resources of two layers (e.g., Layer 1 and Layer 2). In one or more embodiments of the present invention, the number of layers is not limited to two and may be three or more layers. In FIGS. 2A-2F, the CW may be mapped to the resource in order of the number indicated in the resource. Here the exact CW mapping may be different from the FIGS. 2A-2F considering multiplexing other physical signals and channels, frequency/time/layer interleaving and layer permutation that is additionally performed on top of the CW mapping.

In the first CW mapping method, as shown in FIG. 2A, for example, initially, the CW may be mapped, along the time axis direction, to the resources on the first frequency resource in the Layer 1. Then, the CW may be mapped, along the time axis direction, to the resources on the second frequency resource in the Layer 1. After the CW is mapped to the resources in the Layer 1, the CW is mapped in order of the time resource and the frequency resource in the Layer 2. Thus, according to the first CW mapping method, the CW may be mapped in order of the time resource, the frequency resource, and the layer. The mapping order the first CW mapping method may be indicated as “time-frequency-layer.”

In the second CW mapping method, as shown in FIG. 2B, for example, initially, the CW may be mapped, along the time axis direction, to the resources on the first frequency resource in the Layer 1. Then, the CW may be mapped, along the time axis direction, to the resources on the first frequency resource in the Layer 2. Turning to the Layer 1, the CW may be mapped, along the time axis direction, to the resources on the second frequency resource in the Layer 1. Thus, according to the second CW mapping method, the CW may be mapped in order of the time resource, the layer, and the frequency resource (time-layer-frequency).

In the third CW mapping method, as shown in FIG. 2C, for example, initially, the CW may be mapped, along the frequency axis direction, to the resources on the first time resource in the Layer 1. Then, the CW may be mapped, along the frequency axis direction, to the resources on the second time resource in the Layer 1. After the CW is mapped to the resources in the Layer 1, the CW is mapped in order of the frequency resource and the time resource in the Layer 2. Thus, according to the third CW mapping method, the CW may be mapped in order of the frequency resource, the time resource, and the layer (frequency-time-layer).

In the fourth CW mapping method, as shown in FIG. 2D, for example, initially, the CW may be mapped, along the frequency axis direction, to the resources on the first time resource in the Layer 1. Then, the CW may be mapped, along the frequency axis direction, to the resources on the first time resource in the Layer 2. Turning to the Layer 1, the CW may be mapped, along the frequency axis direction, to the resources on the second frequency resource in the Layer 1. Thus, according to the fourth CW mapping method, the CW may be mapped in order of the frequency resource, the layer, and the time resource (frequency-layer-time).

In the fifth CW mapping method, as shown in FIG. 2E, for example, initially, the CW may be mapped to the resource on the first frequency resource and the first time resource in the Layer 1. Then, the CW may be mapped to the resource on the first frequency resource and the first time resource in the Layer 2. Turning to the Layer 1, the CW is mapped to the resource on the first frequency resource and the second time resource in the Layer 1. Thus, according to the fifth CW mapping method, the CW may be mapped in order of the layer, the time resource, and the frequency resource (layer-time-frequency).

In the sixth CW mapping method, as shown in FIG. 2F, for example, initially, the CW may be mapped to the resource on the first frequency resource and the first time resource in the Layer 1. Then, the CW may be mapped to the resource on the first frequency resource and the first time resource in the Layer 2. Turning to the Layer 1, the CW is mapped to the resource on the second frequency resource and the first time resource in the Layer 1. Thus, according to the sixth CW mapping method, the CW may be mapped in order of the layer, the frequency resource, and the time resource (layer-frequency-time).

In one or more embodiments of the present invention, for example, when an ultra-reliable low latency communication (URLLC) scenario is applied, order of the frequency resource and the layer without the time resource (time domain) may be determined in the first to sixth CW mapping methods, because a transmission signal length may be limited unit time (e.g., 1 OFDM symbol) in the URLLC scenario.

In one or more embodiments of the present invention, diversity gain in the first to sixth CW mapping methods may be different from each other.

### FIRST EXAMPLE

According to one or more embodiments of a first example of the present invention, the CW may be mapped using a selected CW mapping method. FIG. 3 is a flowchart diagram showing an operation example of the CW mapping in the TRP 20 according to one or more embodiments of the first example of the present invention.

As shown in FIG. 3, at step S11, the TRP 20 may perform channel coding, rate matching, and Hybrid Automatic Repeat reQuest (HARQ) process of transmission data (transport blocks). As a result of the channel coding process at the step S11, the CWs may be generated. Then, at step S12, the TRP 20 may select the CW mapping method from the above first to sixth CW mapping methods. In other words, the TRP 20 may determine the mapping order of the time resource, the frequency resource, and the layer for the CW mapping. At step S13, in the TRP 20, the CW may be mapped using the selected CW mapping method.

According to one or more embodiments of a first example of the present invention, the TRP 20 may switch the CW mapping method used for the CW mapping dynamically or semi-statically. Furthermore, the TRP 20 may notify the UE 10 of the selected CW mapping method using at least one of Media Access Control Control Element (MAC CE) and Downlink Control Information (DCI) and/or Radio Resource Control (RRC) signaling. As another example, the TRP 20 may implicitly switch the CW mapping method used for the CW mapping.

For example, in MIMO transmission, transmission quality between layers (e.g., Layer 1 and Layer 2) may differ greatly. In one or more embodiments of the first example of the present invention, the spatial diversity gain may be effectively acquired by using the fifth or sixth CW mapping method for the CW mapping.

Furthermore, according to frequency selective fading, the transmission quality may differ at different frequency locations (e.g., subcarrier). In one or more embodiments of the first example of the present invention, the frequency diversity gain may be effectively acquired by using the third or fourth CW mapping method for the CW mapping.

Furthermore, according to Doppler variability of the transmission path, the transmission quality may differ at different time domain locations (e.g., OFDM symbol). In one or more embodiments of the first example of the present invention, the time diversity gain may be effectively acquired by using the first or second CW mapping method for the CW mapping.

Although the above diversity effects may vary according to propagation environment and a moving speed of the nodes, etc., the frequency diversity gain may be larger than the time diversity gain and the spatial diversity gain may be larger than frequency diversity gain.

In wireless communication, it is important to reduce the signal processing latency of receiving data. It may be effective to divide a single code block (CB) in each layer and/or the frequency domain so that a receiver can decode the signal in each received CB. In one or more embodiments of the first example of the present invention, the CW mapping using the sixth (or fourth) CW mapping method may be beneficial in such a case.

### SECOND EXAMPLE

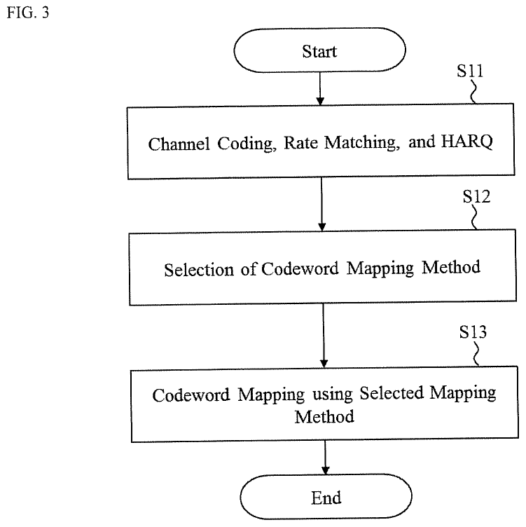

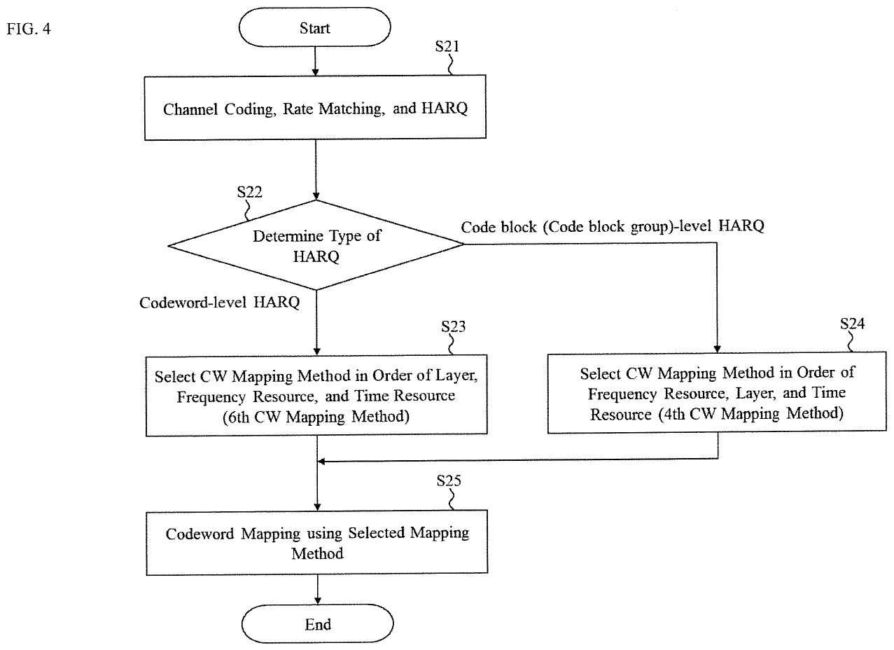

In NR, in addition to the HARQ in each CW (CW-level HARQ), the HARQ in each CB (code block group (CBG)) (CB (CBG)-level HARQ) is applied. A single CW is composed of one to dozens of CBs. According to one or more embodiments of a second example of the present invention, order of the CW mapping (CW mapping method) may be determined based on the type of HARQ. FIG. 4 is a flowchart diagram showing an operation example of the CW mapping in the TRP 20 according to one or more embodiments of the second example of the present invention.

As shown in FIG. 4, at step S21, the TRP 20 may perform channel coding, rate matching, and the HARQ of transmission data (transport blocks).

At step S22, the TRP 20 may determine a type of the HARQ applied at the step S21. The type of the HARQ may be the CW-level HARQ and the CB (CBG)-level HARQ.

When the type of the HARQ is determined as the CW-level HARQ at the step S22, at step S23, the TRP 20 may select the sixth CW mapping method. At the step S23, the TRP 20 may select the fifth CW mapping method. In the CW-level HARQ, when an error of any one of the CBs within the CW is detected, re-transmission is performed. Accordingly, it may be beneficial to secure a predetermined level of the reception quality of the CBs by acquiring the spatial diversity effect using the sixth (or fifth) CW mapping method.

As another example, at the step S23, to acquire the frequency diversity effect, the fourth (or third) CW mapping method may be selected for CW-level HARQ.

On the other hand, the type of the HARQ is determined as the CB (CBG)-level HARQ at the step S22, at step S24, the TRP 20 may select the fourth CW mapping method. The CB (CBG)-level HARQ can provide a detailed re-transmission control method. Accordingly, it may be important to avoid burst errors by differentiating the reception quality of the CBs using the fourth CW mapping method.

As another example, at the step S24, the CW may be mapped so as to acquire the layer, frequency, and time diversity effects for multiple CBs with a single CBG.

At step S25, in the TRP 20, the CW may be mapped using the selected CW mapping method.

### THIRD EXAMPLE

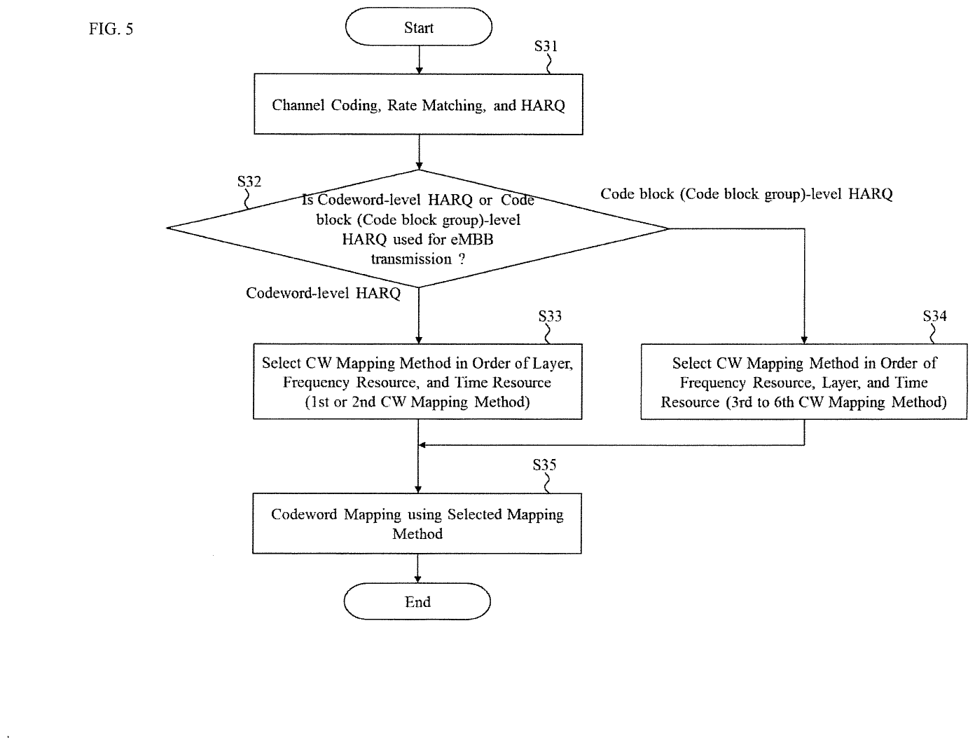

In NR, the URLLC scenario has been studied. In the URLLC, scheduling in each OFDM symbol can be performed to realize low latency of the data transmission. For example, when the URLLC and a service other than the URLLC such as an enhanced mobile broad band (eMBB) may be used in the same system, part of eMBB packets in a time domain may be overwritten by URLLC packets. According to one or more embodiments of a third example of the present invention, order of the CW mapping (CW mapping method) may be determined based on the type of HARQ used for eMBB transmission. FIG. 5 is a flowchart diagram showing an operation example of the CW mapping in the TRP 20 according to one or more embodiments of the second example of the present invention.

As shown in FIG. 5, at step S31, the TRP 20 may perform channel coding, rate matching, and the HARQ of transmission data (transport blocks).

At step S32, the TRP 20 may determine a type of the HARQ used for the eMBB transmission. The type of the HARQ may be the CW-level HARQ and the CB (CBG)-level HARQ.

When the type of the HARQ used for the eMBB transmission is determined as the CW-level HARQ at the step S32, at step S33, the TRP 20 may select the first or second CW mapping method to distribute influences caused by overwriting of the URLLC packet. At the step S33, the TRP 20 may select the fifth CW mapping method to avoid burst error caused by URLLC packet.

On the other hand, the type of the HARQ used for the eMBB transmission is determined as the CB (CBG)-level HARQ at the step S32, at step S34, the TRP 20 may select the third, fourth or sixth CW mapping method to cause the collision a specific CB (CBG) packet and the URLLC packet.

At step S35, in the TRP 20, the CW may be mapped using the selected CW mapping method. Here, the type of service, e.g., eMBB or URLLC, may not be explicitly informed to UE. In this sense, as another example, CW mapping can be implicitly switched depending on HARQ schemes, etc.

### THIRD MODIFIED EXAMPLE

According to one or more embodiments of a third example of the present invention, the CW mapping method may be switched based on a type of the service (difference of scheduling unit). For example, when the URLLC is applied, the TRP 200 may select the sixth CW mapping method. For example, when the eMBB is applied, the TRP 200 may select the first CW mapping method. The service types can be determined according to bearer types, QCI or which scheduling request (SR) is used for data scheduling.

### FOURTH EXAMPLE

Frequency hopping between slots in uplink can be used. In a frame (or slot) configuration, the frequency diversity effect may be acquired to prioritize mapping in the time axis direction. According to one or more embodiments of a fourth example of the present invention, when the frequency hopping between the slots is applied, the first or second CW mapping method (or the fifth CW mapping method).

In one or more embodiments of a fourth example of the present invention, the CW mapping method may be switched in accordance with whether the frequency hopping is applied.

As another example, CW mapping is performed in the order of Slot→Layer→Frequency→OFDM symbol, when slot-level frequency hopping is applied.

### FIFTH EXAMPLE

According to one or more embodiments of a fifth example of the present invention, the TRP 20 may notify the UE 10 of the number of the OFDM symbols per TTI including data (e.g., using at least DCI (DL/UL grant)).

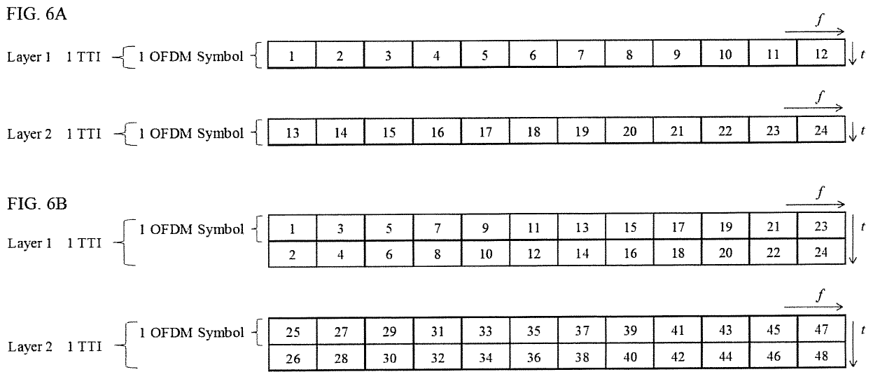

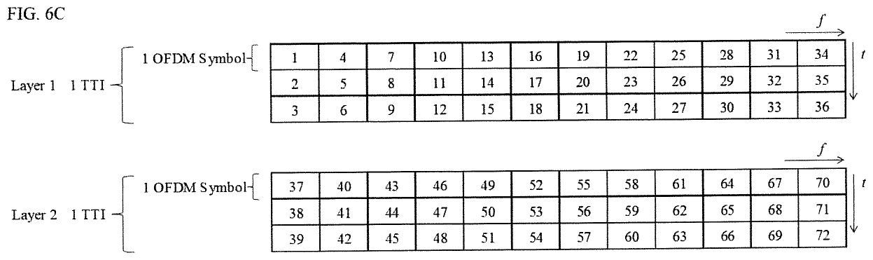

In one or more embodiments of the fifth example of the present invention, as shown in FIGS. 6A, 6B and 6C, the CW within a TTI may be mapped in order of the time resource, the frequency resource, and the layer (time-frequency-layer). The number of the OFDM symbols per TTI in FIGS. 6A, 6B, and 6C is one, two, and three, respectively.

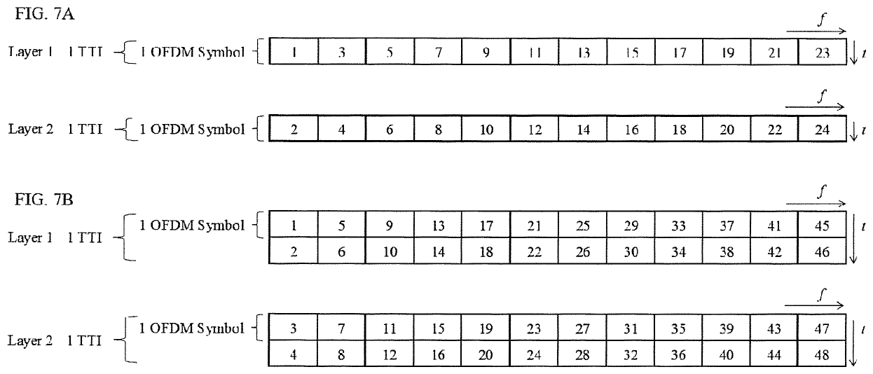

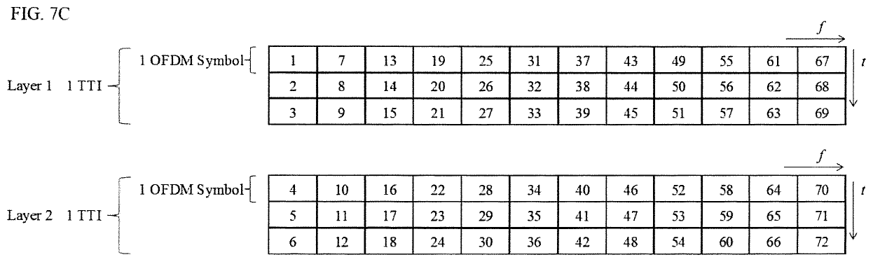

As another example of order of the CW mapping, as shown in FIGS. 7A, 7B and 7C, the CW may be mapped in order of the time resource, the layer, and the frequency resource, (time-layer-frequency). The number of the OFDM symbols per TTI in FIGS. 7A, 7B, and 7C is one, two, and three, respectively.

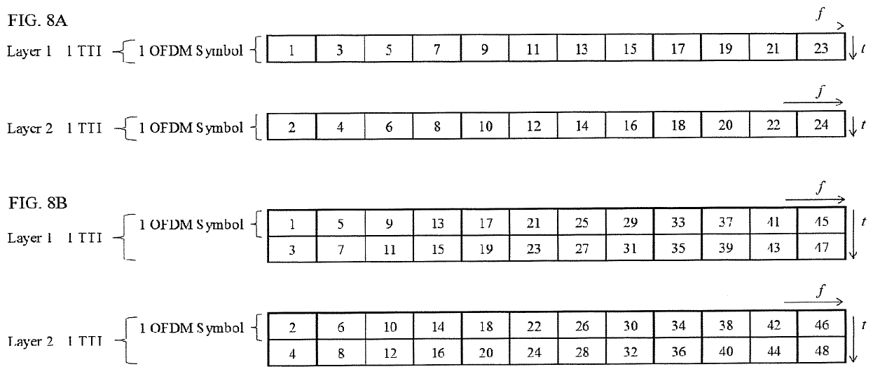

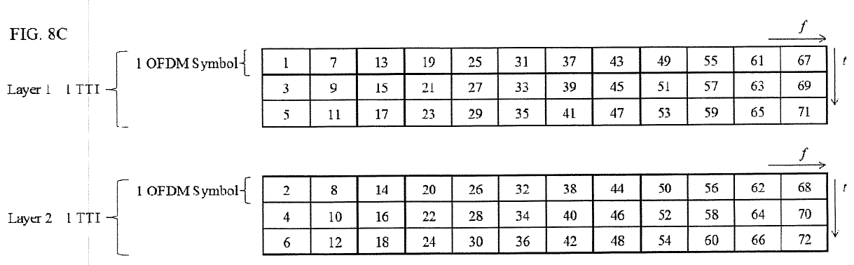

As another example of order of the CW mapping, as shown in FIGS. 8A, 8B and 8C, the CW may be mapped in order of the layer, the time resource, and the frequency resource, (layer-time-frequency). The number of the OFDM symbols per TTI in FIGS. 8A, 8B, and 8C is one, two, and three, respectively.

Furthermore, the above first to sixth CW mapping methods may be applied to a CW mapping method according to one or more embodiments of the fifth example of the present invention.

In one or more embodiments of the fifth example of the present invention, the number of CBs (CBGs) per TTI may be fixed to a predetermined value (e.g., 1).

### FIFTH MODIFIED EXAMPLE

According to one or more embodiments of a fifth modified example of the present invention, the TRP 20 may notify the UE 10 of the number of the TTIs including data scheduled by the DCI (e.g., using at least DCI (DL/UL grant)).

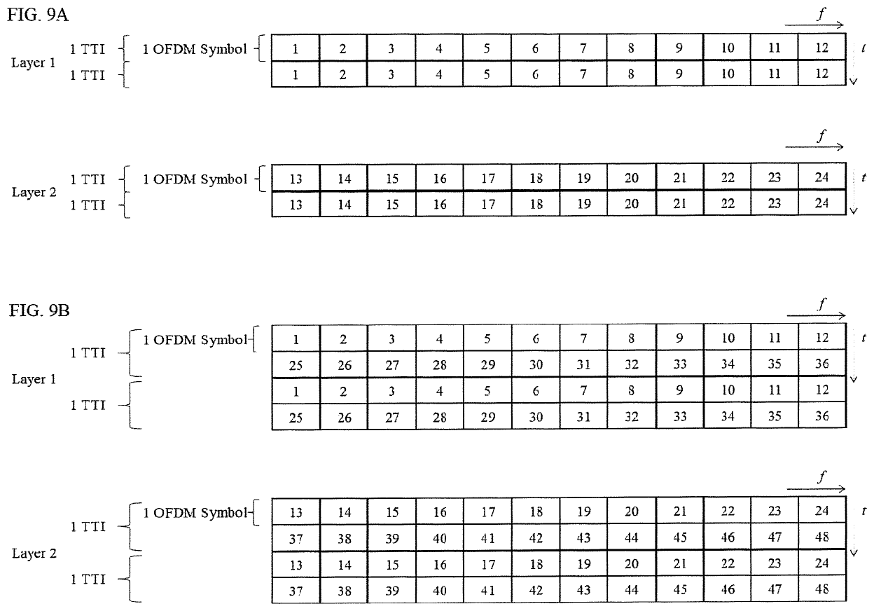

In one or more embodiments of the fifth modified example of the present invention, as shown in FIGS. 9A and 9B, the CW within the scheduled TTI may be mapped in order of the frequency resource, the layer, and the time resource (frequency-layer-time). The number of the OFDM symbols per two TTIs in FIGS. 9A and 9B is two and four, respectively.

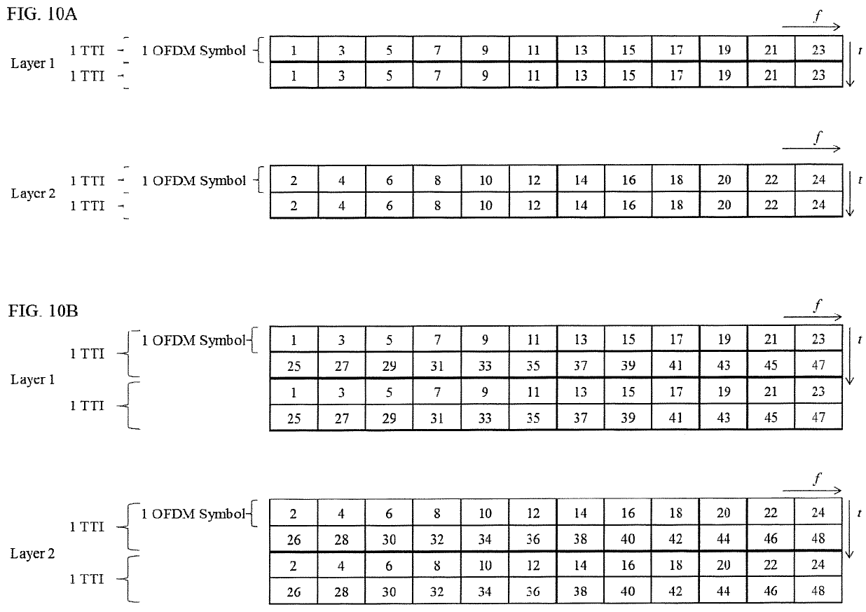

As another example of order of the CW mapping, as shown in FIGS. 10A and 10B, the CW may be mapped in order of the layer, the frequency resource, and the time resource (layer-frequency-time). The number of the OFDM symbols per two TTIs in FIGS. 10A and 10B is two and four, respectively.

Furthermore, the above first to sixth CW mapping methods may be applied to a CW mapping method according to one or more embodiments of the fifth modified example of the present invention.

In one or more embodiments of the fifth modified example of the present invention, the number of CBs (CBGs) per TTI may be fixed to a predetermined value (e.g., 1).

### SIXTH EXAMPLE

According to one or more embodiments of a sixth example of the present invention, order of the CW mapping may be determined based on configured waveform. For example, UL Discrete Fourier Transform (DFT)-s-OFDM waveform, order of the frequency resource, the layer, and the time resource (frequency-layer-time) or the frequency resource, the time resource, and the layer (frequency-time-layer) may be used for the CW mapping.

### SEVENTH EXAMPLE

According to one or more embodiments of a seventh example of the present invention, as a hybrid way, before RRC-connection is setup, an implicit way or default mapping may be required; after RRC establishment success, L1 signaling or higher layer signaling may be used to indicate the mapping. For example, for Random access message 2 reception and message 3 transmission, for System Information Block (SIB) 1 transmission, the frequency diversity gain may be more important than pipeline processing.

According to one or more embodiments of the seventh example of the present invention, different CW may be applied for the SIB and unicast data for downlink. For example, (1) DCI format 1C type of scheduling case may apply CW mapping rule X, while DCI format 2 type of scheduling case may apply CW mapping rule Y. For example, (1) common search space (C-SS) scheduling case apply CW mapping rule X, while UE-specific search space (UE-SS) scheduling case apply CW mapping rule Y

### EIGHTH EXAMPLE

According to one or more embodiments of an eighth example of the present invention, the same CW mapping method may be applied to the initial transmission and re-transmission (or the number of transmission/re-transmission).

As another example, according to one or more embodiments of the eighth example of the present invention, the different CW mapping method may be applied to the initial transmission and re-transmission (or the number of transmission/re-transmission). For example, in the initial transmission, the CW may be mapped in order of the frequency resource, the layer, and the time (frequency-layer-time). For example, in the first and second re-transmission, the CW may be mapped in order of the frequency resource, the layer, and the time (frequency-layer-time). In the third re-transmission, the CW may be mapped in order of the time resource, the layer, and the frequency resource (time-layer-frequency).

As another example, according to one or more embodiments of the eighth example of the present invention, the different CW may be applied for Msg3 and unicast data for uplink. For example, (1) TC-RNTI case may apply CW mapping rule X, while C-RNTI case may apply CW mapping rule Y. For example, (1) C-SS scheduling case may apply CW mapping rule X, while UE-SS scheduling case apply CW mapping rule Y.

(Configuration of TRP)

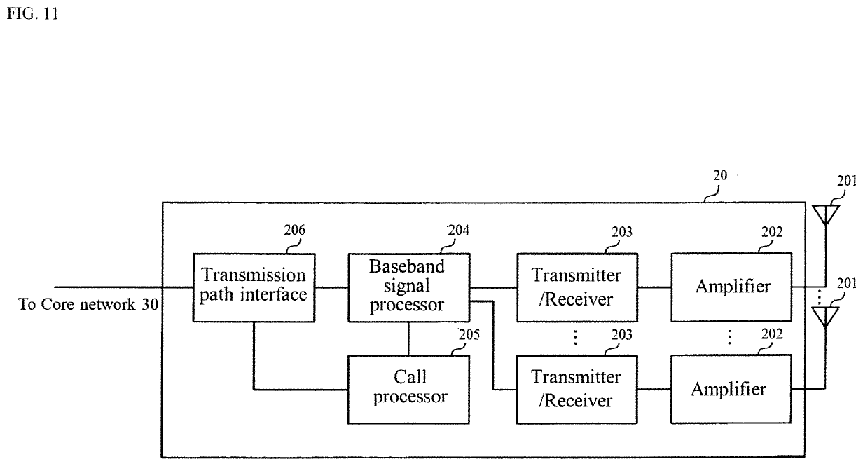

The TRP 20 according to one or more embodiments of the present invention will be described below with reference to FIG. 11. FIG. 11 is a diagram illustrating a schematic configuration of the TRP 20 according to one or more embodiments of the present invention. The TRP 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the TRP 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the TRP 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the TRP 20, and manages the radio resources.

(Configuration of User Equipment)

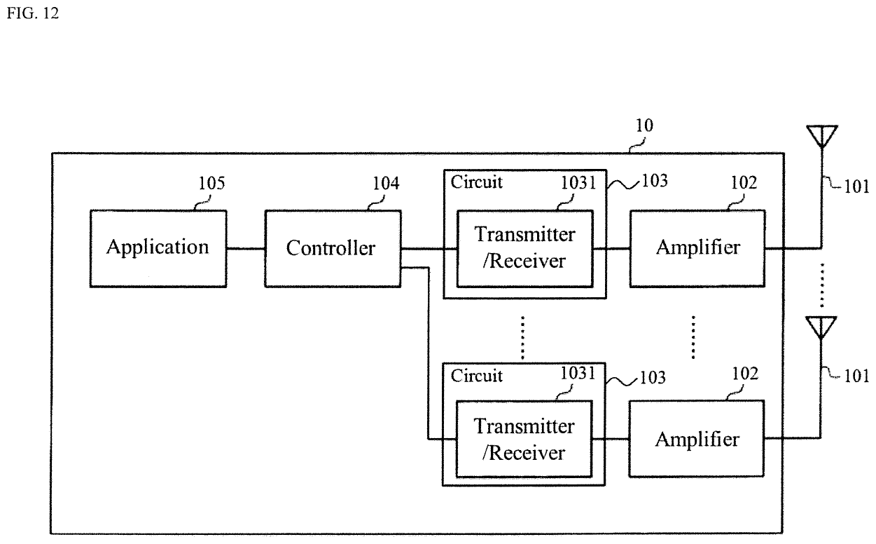

The UE 10 according to one or more embodiments of the present invention will be described below with reference to FIG. 12. FIG. 12 is a schematic configuration of the

UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention may be used for each of the uplink and the downlink independently. One or more embodiments of the present invention may be also used for both of the uplink and the downlink in common.

Although the present disclosure mainly described examples of a channel and signaling scheme based on NR, the present invention is not limited thereto. One or more embodiments of the present invention may apply to another channel and signaling scheme having the same functions as NR such as LTE/LTE-A and a newly defined channel and signaling scheme.

Although the present disclosure mainly described examples of technologies based on the CSI-RS, the present invention is not limited thereto. One or more embodiments of the present invention may apply to another synchronization signal, reference signal, and physical channel such as Primary Synchronization Signal/Secondary Synchronization Signal (PSS/SSS) and Sounding Reference Signal (SRS).

Although the present disclosure described examples of various signaling methods, the signaling according to one or more embodiments of the present invention may be explicitly or implicitly performed.

Although the present disclosure mainly described examples of various signaling methods, the signaling according to one or more embodiments of the present invention may be the higher layer signaling such as the RRC signaling and/or the lower layer signaling such as the DCI and the MAC CE. Furthermore, the signaling according to one or more embodiments of the present invention may use a Master Information Block (MIB) and/or a System Information Block (SIB). For example, at least two of the RRC, the DCI, and the MAC CE may be used in combination as the signaling according to one or more embodiments of the present invention.

In one or more embodiments of the present invention, the RB and a subcarrier in the present disclosure may be replaced with each other. A subframe, a symbol, and a slot may be replaced with each other.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of codeword (CW) mapping in a wireless communication system, the method comprising:
determining, with a Transmission and Reception Point (TRP), order of resources mapped to the CW; and
mapping, with the TRP, the CW to resources in accordance with the determined order.

2. The method according to claim 1, wherein the order of resources is determined based on a frequency resource, a time resource, and a layer.

3. The method according to claim 2, wherein the determining determines the order based on a type of re-transmission control.

4. The method according to claim 3, wherein the type of re-transmission control is CW-level Hybrid Automatic Repeat Request (HARQ) and code block group (CBG)-level HARQ.

5. The method according to claim 4, wherein when the CW-level HARQ is applied, the determining determines the order as order of the layer, the frequency resource, and the time resource.

6. The method according to claim 4, wherein when the CBG-level HARQ is applied, the determining determines the order as order of the frequency resource, the layer, and the time resource.

7. The method according to claim 4, wherein in enhanced mobile broad band (eMBB) using the CW-level HARQ, the determining determines the order as order of the time resource, the frequency, and the layer or the time resource, the layer, and the frequency resource.

8. The method according to claim 4, wherein in eMBB using the CBG-level HARQ, the determining determines the order as order of the frequency resource, the layer, and the time resource.

9. The method according to claim 2,
wherein the determining determines the order based on a service type,
wherein the service type is ultra-reliable low latency communication (URLLC) and eMBB.

10. The method according to claim 3, wherein the service type is the URLLC, the determining determines the order as order of the layer, the frequency resource, and the time resource.

11. The method according to claim 3, wherein the service type is the URLLC, the determining determines the order as order of the time resource, the frequency resource, and the layer.

12. The method according to claim 3, wherein when frequency hopping between slots, the determining determines the order as order of the time resource, the frequency, and the layer or the time resource, the layer, and the frequency resource.

13. The method according to claim 1, further comprising:
notifying, with the TRP, a user equipment (UE) of the determined order.

14. A Transmission and Reception Point (TRP) comprising:
a processor that determines order of resources mapped to codeword (CW); and
a transmitter that notifies a user equipment (UE) of the determined order,
wherein the processor that maps the CW to resources in accordance with the determined order.

15. The TRP according to claim 14, wherein the order of resources is determined based on a frequency resource, a time resource, and a layer.

16. The TRP according to claim 15, wherein the processor determines the order based on a type of re-transmission control.

17. The TRP according to claim 16, wherein the type of re-transmission control is CW-level Hybrid Automatic Repeat Request (HARQ) and code block group (CBG)-level HARQ.

18. The TRP according to claim 17, wherein when the CW-level HARQ is applied, the processor determines the order as order of the layer, the frequency resource, and the time resource.

19. The TRP according to claim 17, wherein when the CBG-level HARQ is applied, the processor determines the order as order of the frequency resource, the layer, and the time resource.

20. The TRP according to claim 17, wherein in enhanced mobile broad band (eMBB) using the CW-level HARQ, the processor determines the order as order of the time resource, the frequency, and the layer or the time resource, the layer, and the frequency resource.
